(19) United States
(12) Patent Application Publication
(10) Pub. No.: US 2017/0009396 A1
(43) Pub. Date: Jan. 12, 2017

(54) FABRIC WITH SURFACE COOLING FUNCTION AND PREPARATION METHOD THEREFOR

(71) Applicant: THE HONG KONG RESEARCH INSTITUTE OF TEXTILES AND APPAREL LIMITED, Hong Kong (HK)

(72) Inventors: Zijian Zheng, Hong Kong (HK); Yi Li, Hong Kong (HK); Haozhong Xin, Hong Kong (HK); Allan Chan, Hong Kong (HK); Hong Hu, Hong Kong (HK); Xuechang Zhou, Hong Kong (HK); Zhilu Liu, Hong Kong (HK)

(21) Appl. No.: 15/121,032

(22) PCT Filed: Dec. 10, 2014
(86) PCT No.: PCT/CN2014/093463

§ 371 Date: Aug. 24, 2016

(30) Foreign Application Priority Data
Feb. 24, 2014 (CN) 201410063363.X

(51) Int. Cl. D06M 15/233; D06M 11/44; D06M 23/10; D06M 11/46; D06M 13/513; C08F 222/08; D06M 11/45

(52) U.S. Cl. CPC D06M 15/233; C08F 222/08; D06M 11/44; D06M 11/45; D06M 11/46; D06M 13/5135; D06M 23/10; D06M 2101/04

(57) ABSTRACT

The present application provides a type of fabric with a surface cooling function and a preparation method therefor. The preparation method comprises the following steps: S1. using a surface cooling material to generate a polymer-modified surface cooling material by in-situ polymerization; S2. dispersing the polymer-modified surface cooling material in a finishing solvent to obtain a functionalized fabric finishing solution; and S3. absorbing the functionalized fabric finishing solution into the fabric and then finishing the fabric with the polymer-modified surface cooling material by thermal treatment, so as to obtain the fabric with the surface cooling function. The fabric with the surface cooling function in the present application feels good and is breathable. The solution of the preparation method for the fabric with the surface cooling function in the present application is simple and feasible and applicable to large-scale production.

### TECHNICAL FIELD

The present application relates to a clothing finishing method, which combines the synthesis of functionalized polymer core-shell particles, the preparation of binder-free clothing finishing agents and the improvement of the clothing cool feeling, which belongs to a preparation method and technology of functional textiles field, and more particularly relates to a fabric with a surface cooling function and a preparation method therefor.

### BACKGROUND

In recent years, global warming has become an increasingly serious problem. Rising temperatures make the summer hotter and longer, which results in that more energy is needed for cooling in tropical and subtropical cities such as Hong Kong. Thus more carbon dioxide is discharged and the global warming is exacerbated. The present application intends to develop a binder-free finishing technology for a fabric with a surface cooling function to get an air permeable and comfortable fabric that has a rapid cooling on contact with the skin to keep the skin cool, which will decrease the energy consumption for cooling.

Currently, researchers mainly research and develop clothes with cool feeling via following three principal ways: 1) forming some specific structures, such as 3D textile, via weaving and/or knitting mixed yarns; 2) forming synthetic fibers in which the core is heat dissipating materials; 3) finishing inorganic nanoparticles on clothes with binders. Although clothes with cooling feeling can be prepared by using the above methods, however these methods also have some drawbacks, such as, the synthetic fiber requires complicated spinning processes, the binder finishing presents poor feeling and breathability. Therefore, people want to have a simple and practical clothing finishing method to prepare air permeable clothes with cool feeling and good handfeel.

### SUMMARY

Aiming at the above-mentioned drawback of the fabric with a surface cooling function that has a poor feeling and breathability, the present application is to provide a fabric with a surface cooling function and a preparation method therefor, wherein, the clothes is air permeable and has a good cool feeling and handfeel.

The technical solutions of the present application for solving the technical problems are as follows.

According to one aspect of the present application, a preparation method for preparing a fabric with a surface cooling function is provided, which comprising the following steps:

step S 1, using a surface cooling material to generate a polymer-modified surface cooling material by an in-situ polymerization:

step S2, dispersing the polymer-modified surface cooling material in a finishing solvent to obtain a functionalized fabric finishing solution; and

step S3, absorbing the functionalized fabric finishing solution into the fabric and then finishing the fabric with the polymer-modified surface cooling material by a thermal treatment, so as to obtain the fabric with the surface cooling function.

In the preparation method for preparing a fabric with a surface cooling function of the present application, wherein the step S1 comprises:

grafting a siloxane on a molecular of the surface cooling material and synthesizing a monomer by the in-situ polymerization on the molecular of the surface cooling material to obtain the polymer-modified surface cooling material.

In the preparation method for preparing a fabric with a surface cooling function of the present application, the surface cooling material is a metal oxide nanoparticle.

In the preparation method for preparing a fabric with a surface cooling function of the present application, the metal oxide nanoparticle is one selected from the group consisting of Zinc oxide nanoparticles, Aluminum oxide nanoparticles and Titanium dioxide nanoparticles.

In the preparation method for preparing a fabric with a surface cooling function of the present application, the siloxane has a vinyl.

In the preparation method for preparing a fabric with a surface cooling function of the present application, the siloxane is 3-trimethoxysilyl propyl methacrylate.

In the preparation method for preparing a fabric with a surface cooling function of the present application, the polymer and the monomer each have a functional group chemically reacting with the fabric.

In the preparation method for preparing a fabric with a surface cooling function of the present application, the monomer comprises one or more selected from the group consisting of acrylate, methacrylate, vinyl ether, maleic anhydride, butadiene and its derivatives, and acrylamide.

In the preparation method for preparing a fabric with a surface cooling function of the present application, the monomer comprises styrene and maleic anhydride.

In the preparation method for preparing a fabric with a surface cooling function of the present application, the functionalized fabric finishing solution further comprises a dispersant and a first assistant additive.

In the preparation method for preparing a fabric with a surface cooling function of the present application, the first assistant additive comprises a catalyst and a functional agent.

In the preparation method for preparing a fabric with a surface cooling function of the present application, the catalyst is sodium hypophosphite or sodium hypophosphite hydrate.

In the preparation method for preparing a fabric with a surface cooling function of the present application, the functional agent is glucose or xylitol.

In the preparation method for preparing a fabric with a surface cooling function of the present application, the finishing solvent comprises water and ethanol.

In the preparation method for preparing a fabric with a surface cooling function of the present application, the dispersant comprises polyacrylic acid or polyacrylate.

In the preparation method for preparing a fabric with a surface cooling function of the present application, wherein the step S3 comprises the following steps:

step Sa31, padding the fabric in the functionalized fabric finishing solution;

step Sa32, drying padded fabric in an oven;

step Sa33, performing the thermal treatment to dried fabric in the oven.

In the preparation method for preparing a fabric with a surface cooling function of the present application, wherein the step S3 comprises the following steps:

step Sb31, soaking the fabric in the functionalized fabric finishing solution;

step Sb32, drying soaked fabric in an oven;

step Sb33, performing the thermal treatment to dried fabric in the oven.

According to another one aspect of the present application, a fabric with a surface cooling function that is prepared by the above preparation method, is provided.

The present application employs the in-situ polymerization to polymerize the surface cooling material onto the fabric, thus the binder is not needed anymore. In such a way, the fabric with the surface cooling function in the present application has good handfeel and better air permeability. The solution of the preparation method for the fabric with the surface cooling function in the present application is simple and feasible and applicable to large-scale production.

### BRIEF DESCRIPTION OF THE DRAWINGS

The present application will be further described with reference to the accompanying drawings and embodiments in the following, in the accompanying drawings:

FIG. 1 is the infrared spectrogram of the ZnO before and after modified, according to the first embodiment of the present application: wherein, the spectrum line a is the infrared spectrogram of ZnO nanoparticles; the spectrum line b is the infrared spectrogram of 3-MPS-ZnO nanoparticles; the spectrum line c is the infrared spectrogram of SMA-ZnO nanoparticles;

FIG. 2 is the SEM image of the ZnO nanoparticles, according to the first embodiment of the present application;

FIG. 3 is the SEM image of the 3-MPS-ZnO nanoparticles, according to the first embodiment of the present application;

FIG. 4 is the SEM image of the SMA-ZnO nanoparticles, according to the first embodiment of the present application;

FIG. 5 is another SEM image of the SMA-ZnO nanoparticles, according to the first embodiment of the present application;

FIG. 6 is the SEM image of the unfinished cotton, according to the first embodiment of the present application;

FIG. 7 is the SEM image of the cotton finished with the SMA-ZnO nanoparticles, according to the first embodiment of the present application;

FIG. 8 is another SEM image of the cotton finished with the SMA-ZnO nanoparticles, according to the first embodiment of the present application;

FIG. 9 is after another SEM image of the cotton finished with the SMA-ZnO nanoparticles, according to the first embodiment of the present application;

FIG. 10 is the curve chart showing the Q-max value change for the unfinished cotton and the cotton finished with the SMA-ZnO nanoparticles under different washing times, according to the first embodiment of the present application;

FIG. 11 is the curve chart showing the UPF value change for the unfinished cotton. and the cotton finished with the SMA-ZnO nanoparticles under different washing times, according to the first embodiment of the present application;

FIG. 12 is the curve chart showing the air resistance change for the unfinished cotton and the cotton finished with the SMA-ZnO nanoparticles under different washing times, according to the first embodiment of the present application.

### DETAILED DESCRIPTION OF THE PREFERRED EMBODIMENT

In the present application, a chemical reaction is occurred between the material with a surface cooling function (hereinafter referred to surface cooling material) and the fabric. By doing this, no binder is needed to finish the surface cooling material onto clothes. Wherein, by the in-situ polymerization, the surface cooling material is functionalized by synthesizing the polymer on the modified surface cooling material with chemical activity. The polymer synthesized on the surface cooling material has at least one functional group chemically reacting with the fabric. Furthermore, the monomer for synthesizing the polymer comprises at least one functional group chemically reacting with the fabric.

Specifically, in the present application, the preparation method for preparing a fabric with a surface cooling function comprises the following steps.

In step 100, a surface cooling material is used to generate a polymer-modified surface cooling material by an in-situ polymerization.

This step further comprises: grafting a siloxane on a molecular of the surface cooling material and synthesizing a monomer by the in-situ polymerization on the molecular of the surface cooling material to obtain the polymer-modified surface cooling material.

The step of grafting the siloxane on the molecular of the surface cooling material comprises:

drying the surface cooling material under vacuum;

adding the vacuum dried surface cooling material to the ethanol solution containing siloxane for implementing a heating reflux operation;

filtering or centrifuging the reaction product that has gone through the heating reflux operation to get the surface cooling material grafted with siloxane, that is the siloxane-modified surface cooling material.

Specifically, in this embodiment, the surface cooling material can be metal oxide nanoparticles, such as Zinc oxide (ZnO) nanoparticles, Titanium dioxide (TiO₂) nanoparticles, Aluminum oxide (Al₂O₃) nanoparticles and so on. The surface cooling material needs to be dried in vacuum before using to remove the adsorbed water and/or other chemical substance. The vacuum drying time for the surface cooling material is 6 h˜72 h. The vacuum drying temperature for the surface cooling material is 60° C.˜120° C.

Then the vacuum dried surface cooling material is added to the ethanol solution containing siloxane for implementing a heating reflux operation. Wherein, each 100 mL of the ethanol solution is mixed with 0.5 g˜50 g of the surface cooling material and 0.5 g˜100 g of the siloxane. The time for heating reflux operation can be 30 min˜72 h. The siloxane has vinyl, such as 3-trimethoxysilyl propyl methacrylate. The reaction product that has gone through the heating reflux operation is filtered or centrifuged to get the siloxane-modified surface cooling material. Then the siloxane-modified surface cooling material is dried in the vacuum oven. The time for drying is 6 h˜72 h. The temperature for drying is 60° C.˜120° C.

Then the siloxane-modified surface cooling material is dispersed into the solution comprising one or more monomers, an initiator, a dispersant and a second assistant additive. Then a polymerization is performed to the siloxane-modified surface cooling material under a certain polymerization temperature and polymerization time. Wherein, the polymerization solvent for the polymerization can dissolve the monomer, the initiator, the dispersant and the second assistant additive. Wherein, each 100 mL of the polymerization solvent is mixed with 0.19˜50 g of the siloxane-modified surface cooling material, 0.1˜50 g of the monomer, 0.001˜10 g of the initiator, 0.001 g˜50 g of the dispersant, 0˜30 g of the second assistant additive. The content of the initiator and the dispersant is adjusted according to the content of the monomer and the polymerization solvent. The monomer comprises at least one vinyl and one functional group that can chemically react with the fiber on the fabric. Specifically, the monomer can be acrylate, methacrylate, vinyl ether, maleic anhydride, butadiene and its derivatives, acrylamide and so on.

Meantime, the initiator is the conventional radical polymerization initiator, such as the azobisisobutyronitrile and the dibenzoyl peroxide. The dispersant can be the polyacrylic acid, the polyacrylate, the amphiphilic nonionic dispersant, the nonionic polymeric dispersant and so on. The second assistant additive refers to the other required chemical reagents, such as the chain transfer agent and the molecular weight modifier and so on. The chain transfer agent can be the water, the alcohol and so on. The molecular weight modifier the alcohol and so on.

Furthermore, the polymerization temperature of the polymerization is related to the type of the monomer. Specifically, the polymerization temperature of the polymerization can be −10° C.˜180° C. and the polymerization time can be 30 min˜48 h. After the polymerization, the polymer-modified surface cooling material is got by filtering or centrifuging, and then vacuum drying. The time for vacuum drying is 6 h˜72 h. The temperature for vacuum drying is 60° C.˜120° C.

In step 200, the polymer-modified surface cooling material is dispersed in a finishing solvent to obtain a functionalized fabric finishing solution.

Specifically, in this step, the polymer-modified surface cooling material, the dispersant, and the first assistant additive are dispersed in the finishing solvent to obtain the functionalized fabric finishing solution. Wherein, the amount of the polymer-modified surface cooling material is about 0.1 wt %˜95 wt % of the finishing solvent. The dispersant can be the polyacrylate, the amphiphilic nonionic dispersant, the nonionic polymeric dispersant and so on. The amount of the dispersant is about 0.01 wt %˜30 wt % of the finishing solvent. The first assistant additive refers to the other required chemical reagents, such as the catalyst, the functional agent and so on. Wherein, the catalyst can be sodium hypophosphite or sodium hypophosphite hydrate. The amount of the first assistant additive is about 0˜50 wt % of the finishing solvent.

Since the surface of the finished fabric is covered with surface cooling material particles having the functional group, a layer of small molecules can be modified to the finished fabric, and thus the surface cooling function of the finished fabric is further improved. In the present application, a layer of small molecules is modified to the finished fabric by introducing the functional agent. Wherein, the functional agent can be the glucose, the xylitol and so on. The functional agent can be added to the finishing solvent to modify the small molecules to the fabric. The amount of the functional agent added into the finishing solvent is 5 wt %˜10 wt %.

In step 300, the functionalized fabric finishing solution is absorbed into the fabric and then the fabric is finished with the polymer-modified surface cooling material by a thermal treatment, so as to obtain the fabric with the surface cooling function.

In this step, the polymer-modified surface cooling material is finished to the fabric by the mode of “padding-predrying-thermal treatment” or “soaking-predrying-thermal treatment”. Specifically, when the functionalized fabric finishing solution is absorbed to the fabric via the padding mode (that is padding the fabric in the functionalized fabric finishing solution), the wet weight gain for the padding is controlled to be 1 wt %˜100 wt %. When the fabric is soaked in the functionalized fabric finishing solution via the soak mode, the soaking time is limited to 10 min˜2 h. And then the fabric absorbed with the functionalized fabric finishing solution by the padding mode or the soaking mode is predried. Wherein, the predrying temperature is −20° C.˜180° C. and the predrying time is 10 s˜1 h. Once again, a thermal treatment is performed to the predried fabric. Wherein, the temperature and time for the thermal treatment are controlled by estimating the reaction characteristics of the fabric and the polymer in advance. Specifically, the temperature for the thermal treatment is controlled to be 80° C.˜180° C. , and the time for the thermal treatment is controlled to be 10 s˜30 min.

When using the mode of “padding-predrying-thermal treatment” or “soaking-predrying-thermal treatment”, the small molecules with a cool feeling can be modified to the surface of the surface cooling material.

When dressing the fabric with a cool feeling prepared by finishing the surface cooling material, at a higher room temperature, the fabric with a cool feeling can bring people a cool feeling and reduce the energy consumption.

The fabric with a surface cooling function and the preparation method therefor of the present application are described by the following specific examples in detail.

### The First Embodiment

In step a1, Zinc oxide (ZnO) nanoparticles are used to generate polymaleic anhydride styrene copolymer-modified Zinc oxide (SMA-ZnO) nanoparticles by the in-situ polymerization.

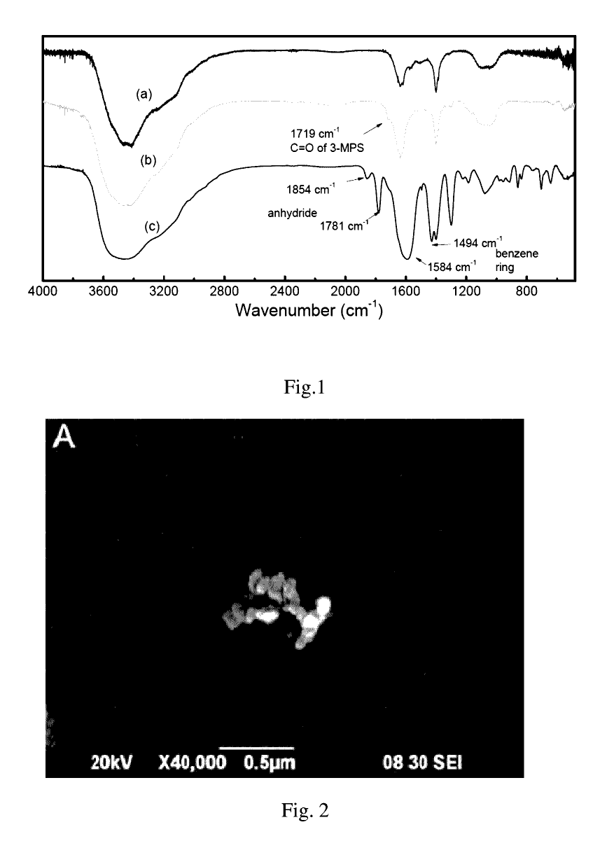

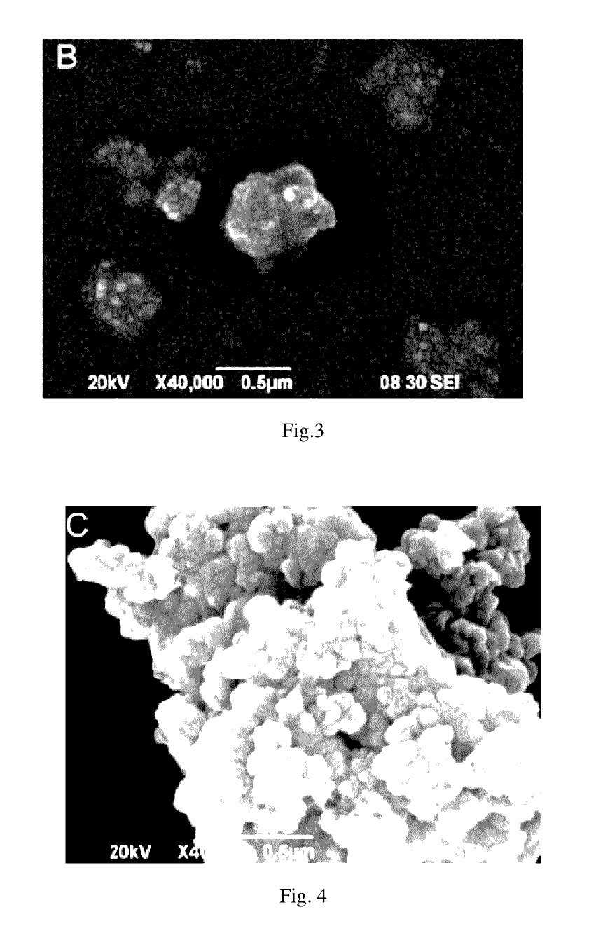

Specifically, the Zinc oxide (ZnO) nanoparticles are vacuum dried in the oven. Wherein, the drying temperature is 80° C., and the drying time is 48 h. Thus the adsorbed water and other chemicals can be removed from the Zinc oxide (ZnO) nanoparticles. Wherein, the infrared spectrogram of the Zinc oxide (ZnO) nanoparticles is shown as the spectrum line a in FIG. 1, and the SEM image of the Zinc oxide (ZnO) nanoparticles is shown in FIG. 2. Then, 10 g of the Zinc oxide (ZnO) nanoparticles and 5 g of the 3-trimethoxysilyl propyl methacrylate (3-M PS) are added to 100 mL of the ethanol respectively to reflux about 8 h. And then the 3-MPS-ZnO nanoparticles are obtained by the centrifugation. The infrared spectrogram of the 3-MPS-ZnOnanoparticles is shown as the spectrum line b in FIG. 1, and the SEM image of the 3-MPS-ZnO nanoparticles is shown in FIG. 3. As shown in FIG. 3, the size of the 3-MPS-ZnO nanoparticles is bigger than that of the ZnO nanoparticles. Then the 3-MPS-ZnO nanoparticle is dried in the oven. The temperature for drying is 80° C. The time for drying is 12 h.

Then, 2 g of the maleic anhydride and 0.4 g of the azobisisobutyronitrile (AIBN) are added to 60mL of the toluene solution comprising 2 wt % of span 80 (SP-80), and then the mixture are heated and stirred until the maleic anhydride and the azobisisobutyronitrile are dissolved to obtain the maleic anhydride-toluene solution. Wherein, the toluene is the polymerization solvent; the AIBN is the initiator; the SP-80 is the dispersant. After that, 8 g of the 3-MPS-ZnO nanoparticles are added to the maleic anhydride-toluene solution, and a reaction is occurred at 70° C. for 10 min to obtain the 3-MPS-ZnO nanoparticles-maleic anhydride-toluene solution.

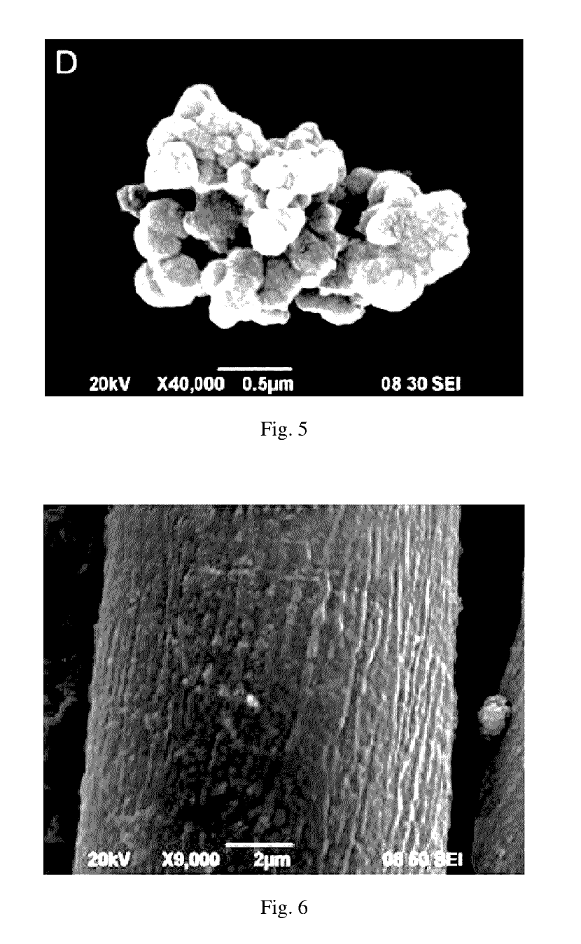

Then 2 g of the styrene is added to 20 mL of the toluene to prepare the styrene-toluene solution. After that, the styrene-toluene solution is slowly added to the prepared 3-MPS-ZnO nanoparticles-maleic anhydride-toluene solution, and a reaction is occurred at 70° C. for 10 min. After that, a reaction is occurred at 80° C. for 2 h to obtain the product that is insoluble in toluene. Wherein, both the maleic anhydride and the styrene are the monomer. The product is then isolated by filtering, and is vacuum dried at 80° C. for 12 h to obtain the polymaleic anhydride styrene copolymer-modified Zinc oxide (SMA-ZnO) nanoparticles. The infrared spectrogram of the SMA-ZnO nanoparticles is shown as the spectrum line c in FIG. 1. The SEM images of the SMA-ZnO nanoparticles are shown in FIG. 4 and FIG. 5. As shown in FIG. 4 and FIG. 5, the size of the SMA-ZnO nanoparticles is increased to be much bigger than that of the ZnO nanoparticles.

In step a2, the SMA-ZnO nanoparticles are dispersed in the finishing solvent to obtain the first functionalized fabric finishing solution.

Specifically, in this step, the finishing solvent is the 100 mL of aqueous solution containing 5 wt % of the ethanol. 2 g of the SMA-ZnO nanoparticles, 0.5 of the sodium polyacrylate and 8 g of the xylitol are added to the 100 mL of aqueous solution containing 3.5 wt % of the hypophosphite and 5 wt % of the ethanol. Then the first functionalized fabric finishing solution is obtained by the ultrasonic dispersion of the obtained aqueous solution. Wherein, the hypophosphite is the catalyst, and the sodium polyacrylate is the dispersant.

In step a3, the first functionalized fabric finishing solution is absorbed into the fabric and then the fabric is finished with the SMA-ZnO nanoparticles by thermal treatment.

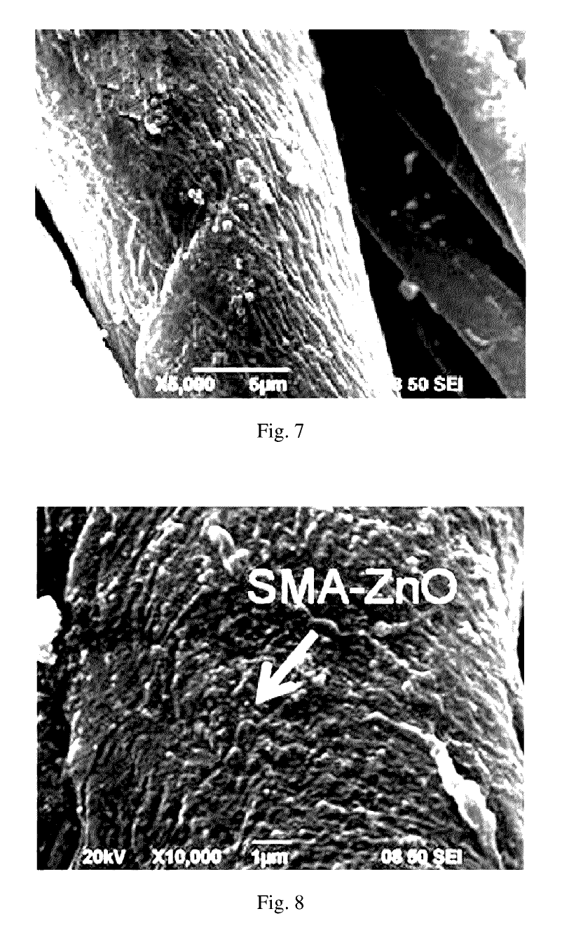

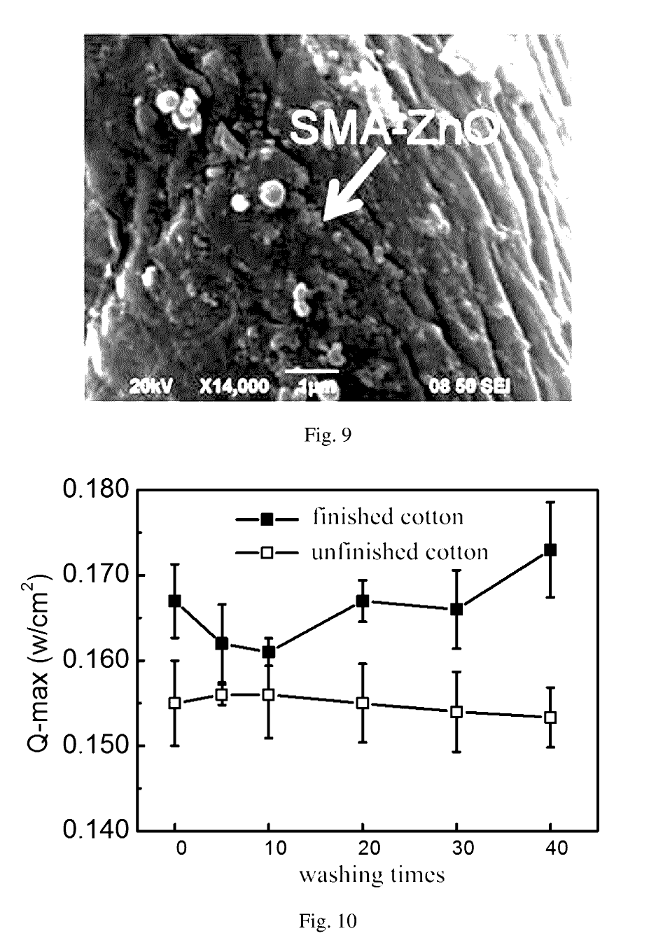

In this step, the SMA-ZnO nanoparticle is finished to the fabric by the mode of “padding-predrying-thermal treatment”. Specifically, 70 wt % of the first functionalized fabric finishing solution is absorbed by the fabric by padding, that is, the wet weight gain for the padding is 70 wt %. And then the fabric absorbed with the first functionalized fabric finishing solution is dried at 100° C. for 2 min, that is the predrying temperature is 100° C. and the predrying time is 2 min. Then the predried fabric absorbed with the first functionalized fabric finishing solution is placed at 180° C. for 2 min, that is the temperature for the thermal treatment 180° C. and the time for the thermal treatment is 2 min. Thus the fabric finished with the SMA-ZnO nanoparticles is obtained. In this embodiment, the fabric is cotton, and the SEM image of the unfinished cotton is shown in FIG. 6. FIG. 7, FIG. 8 and FIG. 9 shows the SEM images of the cotton finished with the SMA-ZnO nanoparticles.

In addition, in this step the SMA-ZnO nanoparticle can be finished to the fabric by the mode of “soaking-predrying-thermal treatment”. Specifically, the fabric is soaked in the first functionalized fabric finishing solution for 15 min, that is, the soaking time is 15 min. After that, the soaked fabric is taken out, and is dried at 100° C. for 2 min, that is, the predrying temperature is 100° C. and the predrying time is 2 min. Then the predried fabric is placed at 180° C. for 2 min, that is, the temperature for the thermal treatment 180° C. and the time for the thermal treatment is 2 min. Thus the fabric finished with the SMA-ZnO nanoparticles is obtained.

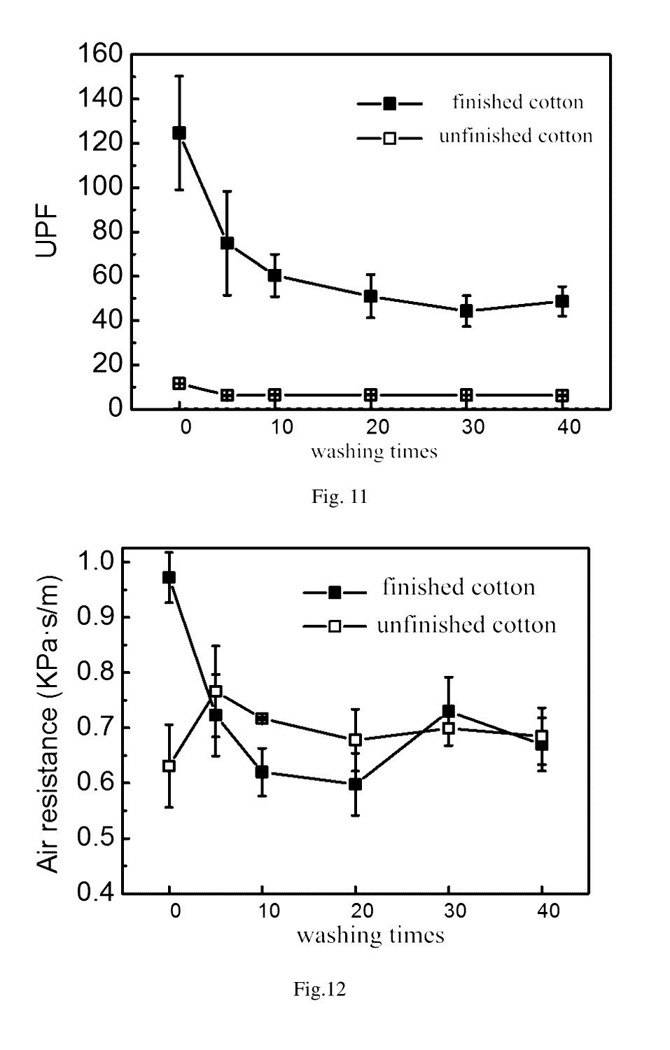

FIG. 10 is the test result of the coldness performance of the unfinished cotton and the cotton finished with the SMA-ZnO nanoparticles. As shown in FIG. 10, the Q-max value of the cotton finished with the SMA-ZnO nanoparticles is obviously bigger than that of the unfinished cotton. Meanwhile, with the increasing washing times, the Q-max value of the cotton finished with the SMA-ZnO nanoparticles decreases at first and then increases. Therefore, the coldness performance of the cotton finished with the SMA-ZnO nanoparticles is better than that of the unfinished cotton. FIG. 11 is the test result of the UV resistance of the unfinished cotton and the cotton finished with the SMA-ZnO nanoparticles. As shown in FIG. 11, the UPF value of the cotton finished with the SMA-ZnO nanoparticles is obviously bigger than that of the unfinished cotton. That is to say, the UV resistance of the cotton finished with the SMA-ZnO nanoparticles is stronger that of the unfinished cotton. FIG. 12 is the curve chart showing the air resistance change for the unfinished cotton and the cotton finished with the SMA-ZnO nanoparticles under different washing times. As shown in FIG. 12, the air resistance performance of the cotton finished with the SMA-ZnO nanoparticles is equivalent to that of the unfinished cotton. That is to say, the effect to the human action of the cotton finished with the SMA-ZnO nanoparticles is equivalent to that of the unfinished cotton. In this embodiment, a cool feeling statistical analysis test is done to the cotton finished with the SMA-ZnO nanoparticles. Specifically, in this embodiment, 10 people are dressed with clothes made from the cotton finished with the SMA-ZnO nanoparticles, and rate the cool feeling under different temperatures about the clothes made from the cotton finished with the SMA-ZnO nanoparticles. Wherein, the scores are −3 (representing vary cool), −2 (representing cool), −1 (representing a little cool), 0 (representing no change), 1 (representing a little warm), 2 (representing warm). Table 1 shows the statistical results of the scores about the cool feeling of the clothes made from the cotton finished with the SMA-ZnO nanoparticles.

TABLE 1

| | statistical values under | | | | | | | | |
|---|---|---|---|---|---|---|---|---|---|
| | different cool comfort | | | | | | percentage | | |
| Temperature | factors | | | | | | | 0 (no | >0 |
| (° C.) | −3 | −2 | −1 | 0 | 1 | 2 | <0 (cool) | change) | (warm) |
| 23 | 1 | 1 | 6 | 1 | 1 | 0 | 80% | 10% | 10% |
| 24 | 0 | 4 | 2 | 3 | 1 | 0 | 60% | 30% | 10% |
| 25 | 0 | 2 | 6 | 2 | 0 | 0 | 80% | 20% | 0 |
| 26 | 1 | 2 | 3 | 4 | 0 | 0 | 60% | 40% | 0 |
| 27 | 1 | 2 | 5 | 2 | 0 | 0 | 80% | 20% | 0 |
| 28 | 2 | 1 | 5 | 2 | 0 | 0 | 80% | 20% | 0 |

As seen from table 1, most people think the cotton finished with the SMA-ZnO nanoparticles is cool.

### The Second Embodiment

In step b1, the Aluminum oxide (Al₂O₃) nanoparticles are used to generate polymaleic anhydride styrene copolymer-modified Aluminum oxide (SMA-Al₂O₃) nanoparticles by the in-situ polymerization.

Specifically, the Aluminum oxide (Al₂O₃) nanoparticles are vacuum dried in the oven. Wherein, the drying temperature is 120° C., and the drying time is 6 h. Thus the adsorbed water and other chemicals can be removed from the Aluminum oxide (Al₂O₃) nanoparticles. Then, 0.5 g of the Aluminum oxide (Al₂O₃) nanoparticles and 0.5 g of the 3-trimethoxysilyl propyl methacrylate (3-MPS) are added to 100 mL of the ethanol respectively to reflux about 30 min. And then the 3-MPS-Al₂O₃ nanoparticles are obtained by the centrifugation. Then the 3-MPS-Al₂O₃ nanoparticles is dried in the oven. The temperature for drying is 120° C. The time for drying is 6 h.

Then, 0.05 g of the maleic anhydride and 0.001 g of the azobisisobutyronitrile (AIBN) are added to 60 mL of the toluene solution comprising 0.01 wt % of span 80 (SP-80), and then the mixture are heated and stirred until the maleic anhydride and the azobisisobutyronitrile are dissolved to obtain the maleic anhydride-toluene solution. Wherein, the toluene is the polymerization solvent, the AIBN is the initiator, the SP-80 is the dispersant. After that, 0.1 g of the 3-MPS-Al₂O₃ nanoparticles are added to the maleic anhydride-toluene solution, and a reaction is occurred at 70° C. for 10 min to obtain the 3-MPS-Al₂O₃ nanoparticles-maleic anhydride-toluene solution.

Then 0.05 g of the styrene is added to 40 mL of the toluene to prepare the styrene-toluene solution. After that, the styrene-toluene solution is slowly added to the prepared 3-MPS-Al₂O₃ nanoparticles-maleic anhydride-toluene solution, and a reaction is occurred at 70° C. for 10 min. After that, a reaction is occurred at 80° C. for 20 min to obtain the product that is insoluble in toluene. Wherein, both the maleic anhydride and the styrene are the monomer. The product is then isolated by filtering, and is vacuum dried at 120° C. for 6 h to obtain the polymaleic anhydride styrene copolymer-modified Aluminum oxide (SMA-Al₂O₃) nanoparticles.

In step b2, the SMA-Al₂O₃ nanoparticles are dispersed in the finishing solvent to obtain the second functionalized fabric finishing solution.

Specifically, in this step, the finishing solvent is the 100 mL of aqueous solution containing 5 wt % of the ethanol. 0.1 g of the SMA-Al₂O₃ nanoparticles, 0.01 g of the sodium polyacrylate and 5 g of the xylitol are added to the 100 mL of aqueous solution containing 5 wt % of the ethanol. Then the second functionalized fabric finishing solution is obtained by the ultrasonic dispersion of the obtained aqueous solution. Wherein, the hypophosphite is the catalyst, and the sodium polyacrylate is the dispersant.

In step b3, the second functionalized fabric finishing solution is absorbed into the fabric and then the fabric is finished with the SMA-Al₂O₃ nanoparticles by thermal treatment.

In this step, the SMA-Al₂O₃ nanoparticle is finished to the fabric by the mode of “padding-predrying-thermal treatment”. Specifically, 1 wt % of the second functionalized fabric finishing solution is absorbed by the fabric by padding, that is, the wet weight gain for the padding is 1 wt %. And then the fabric absorbed with the second functionalized fabric finishing solution is dried at −20° C. for 1 h, that is, the predrying temperature is −20° C. and the predrying time is 1 h. Then the predried fabric absorbed with the second functionalized fabric finishing solution is placed at 160° C. for 10 s, that is, the temperature for the thermal treatment 160° C. and the time for the thermal treatment is 10 s. Thus the fabric finished with the SMA-Al₂O₃ nanoparticles is obtained.

In addition, in this step the SMA-Al₂O₃ nanoparticle can be finished to the fabric by the mode of “soaking-predrying-thermal treatment”. Specifically, the fabric is soaked in the second functionalized fabric finishing solution for 2 h, that is, the soaking time is 2 h. After that, the soaked fabric is taken out, and is dried at −20° C. for 1 h, that is, the predrying temperature is −20° C. and the predrying time is 1 h. Then the predried fabric is placed at 160° C. for 10 s, that is, the temperature for the thermal treatment 160° C. and the time for the thermal treatment is 10 s. Thus the fabric finished with the SMA-Al₂O₃ nanoparticles is obtained.

In this embodiment, a cool feeling statistical analysis test is done to the cotton finished with the SMA-Al₂O₃ nanoparticles. Specifically, in this embodiment, 10 people are dressed with clothes made from the cotton finished with the SMA-Al₂O₃ nanoparticles, and rate the cool feeling under different temperatures about the clothes made from the cotton finished with the SMA-Al₂O₃ nanoparticles. Wherein, the scores are −3 (representing vary cool), −2(representing cool), −1 (representing a little cool), 0 (representing no change), 1 (representing a little warm), 2 (representing warm). Table 2 shows the statistical results of the scores about the cool feeling of the clothes made from the cotton finished with the SMA-Al₂O₃ nanoparticles.

TABLE 2

| | statistical values under | | | | | | | | |
|---|---|---|---|---|---|---|---|---|---|
| | different cool comfort | | | | | | percentage | | |
| Temperature | factors | | | | | | | 0 (no | >0 |
| (° C.) | −3 | −2 | −1 | 0 | 1 | 2 | <0 (cool) | change) | (warm) |
| 23 | 1 | 1 | 6 | 1 | 1 | 0 | 80% | 10% | 10% |
| 24 | 0 | 1 | 5 | 3 | 1 | 0 | 60% | 30% | 10% |
| 25 | 0 | 1 | 6 | 2 | 1 | 0 | 70% | 20% | 10% |
| 26 | 1 | 1 | 3 | 4 | 1 | 0 | 50% | 40% | 10% |
| 27 | 1 | 1 | 6 | 2 | 0 | 0 | 80% | 20% | 0 |
| 28 | 2 | 1 | 5 | 2 | 0 | 0 | 80% | 20% | 0 |

As seen from table 2, most people think the cotton finished with the SMA-Al₂O₃ nanoparticles is cool.

### The Third Embodiment

In step c1, the Titanium dioxide (TiO₂) nanoparticles are used to generate polymaleic anhydride styrene copolymer-modified Titanium dioxide (SMA-TiO₂) nanoparticles by the in-situ polymerization;

Specifically, the Titanium dioxide (TiO₂) nanoparticles are vacuum dried in the oven. Wherein, the drying temperature is 60° C., and the drying time is 72 h. Thus the adsorbed water and other chemicals can be removed from the Titanium dioxide (TiO₂) nanoparticles. Then, 50 g of the Titanium dioxide (TiO₂) nanoparticles and 100 g of the 3-trimethoxysilyl propyl methacrylate (3-MPS) are added to 100 mL of the ethanol respectively to reflux about 72 h. And then the 3-MPS-TiO₂ nanoparticles are obtained by the centrifugation. Then the 3-MPS-TiO₂ nanoparticle is dried in the oven. The temperature for drying is 60° C. The time for drying is 72 h.

Then, 25 g of the maleic anhydride and 10 g of the benzoyl peroxide are added to 60 mL of the toluene solution comprising 50 wt % of span 80 (SP-80), and then the mixture are heated and stirred until the maleic anhydride and the azobisisobutyronitrile are dissolved to obtain the maleic anhydride-toluene solution. Wherein, the toluene is the polymerization solvent, the benzoyl peroxide is the initiator, the SP-80 is the dispersant. After that, 50 g of the 3-MPS-TiO₂ nanoparticles are added to the maleic anhydride-toluene solution, and a reaction is occurred at 70° C. for 10 min to obtain the 3-MPS-TiO₂ nanoparticles-maleic anhydride-toluene solution.

Then 25 g of the styrene is added to 40 mL of the toluene to prepare the styrene-toluene solution. After that, the styrene-toluene solution is slowly added to the prepared 3-MPS-TiO₂ nanoparticles-maleic anhydride-toluene solution, and a reaction is occurred at 70° C. for 8 h. After that, a reaction is occurred at 80° C. for 40 h to obtain the product that is insoluble in toluene. Wherein, both the maleic anhydride and the styrene are the monomer. The product is then isolated by filtering, and is vacuum dried at 60° C. for 72 h to obtain the polymaleic anhydride styrene copolymer-modified Titanium dioxide (SMA-TiO₂) nanoparticles.

In step c2, the SMA-TiO₂ nanoparticles are dispersed in the finishing solvent to obtain the third functionalized fabric finishing solution.

Specifically, in this step, the finishing solvent is the 100 mL of aqueous solution containing 5 wt % of the ethanol. 95 g of the SMA-TiO₂ nanoparticles, 30 g of the sodium polyacrylate and 10 g of the glucose are added to the 100 mL of aqueous solution containing 5 wt % of the ethanol. Then the third functionalized fabric finishing solution is obtained by the ultrasonic dispersion of the obtained aqueous solution. Wherein, the hypophosphite is the catalyst, and the sodium polyacrylate is the dispersant.

In step c3, the third functionalized fabric finishing solution is absorbed into the fabric and then the fabric is finished with the SMA-TiO₂ nanoparticles by thermal treatment.

In this step, the SMA-TiO₂ nanoparticle is finished to the fabric by the mode of “padding-predrying-thermal treatment”. Specifically, 100 wt % of the third functionalized fabric finishing solution is absorbed by the fabric by padding, that is, the wet weight gain for the padding is 100 wt %. And then the fabric absorbed with the third functionalized fabric finishing solution is dried at 180° C. for 10 s, that is, the predrying temperature is 180° C. and the predrying time is 10 s. Then the predried fabric absorbed with the third functionalized fabric finishing solution is placed at 80° C. for 30min, that is, the temperature for the thermal treatment 80° C. and the time for the thermal treatment is 30 min. Thus the fabric finished with the SMA-TiO₂ nanoparticles is obtained.

In addition, in this step the SMA-TiO₂ nanoparticle can be finished to the fabric by the mode of “soaking-predrying-thermal treatment”. Specifically, the fabric is soaked in the third functionalized fabric finishing solution for 10 min, that is, the soaking time is 10 min. After that, the soaked fabric is taken out, and is dried at 180° C. for 10 s, that is, the predrying temperature is 180° C. and the predrying time is 10 s. Then the predried fabric is placed at 80° C. for 30 min, that is, the temperature for the thermal treatment 80° C. and the time for the thermal treatment is 30 min. Thus the fabric finished with the SMA-TiO₂ nanoparticles is obtained.

The present application employs the in-situ polymerization to polymerize the surface cooling material onto the fabric, thus the binder is not needed anymore. In such a way, the fabric with the surface cooling function in the present application has good handfeel and better air permeability. The solution of the preparation method for the fabric with the surface cooling function in the present application is simple and feasible and applicable to large-scale production.

In this embodiment, a cool feeling statistical analysis test is done to the cotton finished with the SMA-TiO₂ nanoparticles. Specifically, in this embodiment, 10 people are dressed with clothes made from the cotton finished with the SMA-TiO₂ nanoparticles, and rate the cool feeling under different temperatures about the clothes made from the cotton finished with the SMA-TiO₂ nanoparticles. Wherein, the scores are −3 (representing vary cool), −2 (representing cool), −1 (representing a little cool), 0 (representing no change), 1 (representing a little warm), 2 (representing warm). Table 2 shows the statistical results of the scores about the cool feeling of the clothes made from the cotton finished with the SMA-TiO₂ nanoparticles.

TABLE 3

| | statistical values under | | | | | | | | |
|---|---|---|---|---|---|---|---|---|---|
| | different cool comfort | | | | | | percentage | | |
| Temperature | factors | | | | | | | 0 (no | >0 |
| (° C.) | −3 | −2 | −1 | 0 | 1 | 2 | <0 (cool) | change) | (warm) |
| 23 | 1 | 4 | 3 | 1 | 1 | 0 | 80% | 10% | 10% |
| 24 | 1 | 4 | 3 | 2 | 0 | 0 | 80% | 20% | 0 |
| 25 | 3 | 4 | 1 | 2 | 0 | 0 | 80% | 20% | 0 |
| 26 | 3 | 4 | 1 | 2 | 0 | 0 | 80% | 20% | 0 |
| 27 | 4 | 3 | 2 | 1 | 0 | 0 | 90% | 10% | 0 |
| 28 | 3 | 4 | 2 | 1 | 0 | 0 | 90% | 10% | 0 |

As seen from table 3, most people think the cotton finished with the SMA-TiO₂ nanoparticles is cool.

It should be noted that, for one skilled in the art, the above description can be improved or modified. Further, all those improvement and modification fall into the protection scope of the present application.

1-18. (canceled)

19. A preparation method for preparing a fabric with a surface cooling function, comprising the following steps:
step S1, using a surface cooling material to generate a polymer-modified surface cooling material by an in-situ polymerization;
step S2, dispersing the polymer-modified surface cooling material in a finishing solvent to obtain a functionalized fabric finishing solution; and
step S3, absorbing the functionalized fabric finishing solution into the fabric and then finishing the fabric with the polymer-modified surface cooling material by a thermal treatment, so as to obtain the fabric with the surface cooling function.

20. The preparation method for preparing a fabric with a surface cooling function according to claim 19, wherein, step S1 comprises:
grafting a siloxane on a molecular of the surface cooling material and synthesizing a monomer by the in-situ polymerization on the molecular of the surface cooling material to obtain the polymer-modified surface cooling material.

21. The preparation method for preparing a fabric with a surface cooling function according to claim 20, wherein, the surface cooling material is a metal oxide nanoparticle.

22. The preparation method for preparing a fabric with a surface cooling function according to claim 21, wherein, the metal oxide nanoparticle is one selected from the group consisting of Zinc oxide nanoparticles, Aluminum oxide nanoparticles and Titanium dioxide nanoparticles.

23. The preparation method for preparing a fabric with a surface cooling function according to claim 20, wherein, the siloxane has a vinyl.

24. The preparation method for preparing a fabric with a surface cooling function according to claim 23, wherein, the siloxane is 3-trimethoxysilyl propyl methacrylate.

25. The preparation method for preparing a fabric with a surface cooling function according to claim 20, wherein, the polymer and the monomer each have a functional group chemically reacting with the fabric.

26. The preparation method for preparing a fabric with a surface cooling function according to claim 25, wherein, the monomer comprises one or more selected from the group consisting of acrylate, methacrylate, vinyl ether, maleic anhydride, butadiene and its derivatives, and acrylamide.

27. The preparation method for preparing a fabric with a surface cooling function according to claim 26, wherein, the monomer comprises styrene and maleic anhydride.

28. The preparation method for preparing a fabric with a surface cooling function according to claim 19, wherein, the functionalized fabric finishing solution further comprises a dispersant and a first assistant additive .

29. The preparation method for preparing a fabric with a surface cooling function according to claim 28, wherein, the first assistant additive comprises a catalyst and a functional agent.

30. The preparation method for preparing a fabric with a surface cooling function according to claim 29, wherein, the catalyst is a sodium hypophosphite or a sodium hypophosphite hydrate.

31. The preparation method for preparing a fabric with a surface cooling function according to claim 29, wherein, the functional agent is glucose or xylitol.

32. The preparation method for preparing a fabric with a surface cooling function according to claim 28, wherein, the finishing solvent comprises water and an ethanol.

33. The preparation method for preparing a fabric with a surface cooling function according to claim 32, wherein, the dispersant comprises polyacrylic acid or polyacrylate.

34. The preparation method for preparing a fabric with a surface cooling function according to claim 19, wherein, the step S3 comprises the following steps:
step Sa31, padding the fabric in the functionalized fabric finishing solution;
step Sa32, drying the padded fabric in an oven;
step Sa33, performing the thermal treatment to the dried fabric in the oven.

35. The preparation method for preparing a fabric with a surface cooling function according to claim 19, wherein, S3 comprises the following steps:
step Sb31, soaking the fabric in the functionalized fabric finishing solution;
step Sb32, drying the soaked fabric in an oven;
step Sb33, performing the thermal treatment to the dried fabric in the oven.

36. A fabric with a surface cooling function, wherein, the fabric is prepared by the preparation method according to claim 19.

37. The fabric with a surface cooling function according to claim 36, wherein a siloxane is grafted on a molecular of the surface cooling material and a monomer is synthesized by the in-situ polymerization on the molecular of the surface cooling material to obtain the polymer-modified surface cooling material.

38. The fabric with a surface cooling function according to claim 37, wherein the surface cooling material is a metal oxide nanoparticle, the polymer and the monomer each have a functional group chemically reacting with the fabric.
